(19) United States
(12) Patent Application Publication
(10) Pub. No.: US 2014/0299729 A1
(43) Pub. Date: Oct. 9, 2014

(54) Idle End for a Roller Blind

(71) Applicant: Norman Wills, Mississauga (CA)

(72) Inventor: Norman Wills, Mississauga (CA)

(21) Appl. No.: 13/857,820

(22) Filed: Apr. 5, 2013

(51) Int. Cl. E06B 9/44; A47H 1/142

(52) U.S. Cl. CPC E06B 9/44; A47H 1/142
USPC 248/254

(57) ABSTRACT

An idle end for a roller blind. The idle end comprises a housing, that includes a roller tube engagement portion for securing the housing to an end of a roller tube, and a pin member secured to the housing. The pin member extends outwardly from the end of the housing and includes a flange. The pin member is releaseably securable to an end bracket of the roller blind with the flange engaging the outer surface of the end bracket upon the application of a force having a component generally parallel to the longitudinal axis of the roller tube, thereby restricting the release of the pin member and the idle end from the end bracket

### FIELD

This invention relates generally to rollers blinds or shades, and in particular to an idle end for a roller blind.

### BACKGROUND

Roller blinds, or roller shades as they are sometimes referred to, are commonly mounted on windows for privacy purposes and to limit light intrusion. Most commonly, roller blinds include a roller tube upon which a fabric is wound. The tube is positioned between two end brackets. The roller tube is rotatable relative to the end brackets to permit the fabric to be either unwound from the tube and lowered in front of the window or wound back on to the tube to present full access to the window. Typically, one end of the roller tube engages a clutch that is secured to a first end bracket. The clutch allows for controlled rotation of the roller tube in either direction through pulling on one end a looped chain or cord, through engagement with a motorized drive unit, etc. The opposite end of the roller tube is most often fitted with an idle end upon which is positioned a pin that may be received within a slot or hole in its related end bracket. The pin serves to “hang” the roller tube from the end bracket that is opposite to the clutch. In some instances, the pin may be secured directly to the idle end that is received within the roller tube such that it rotates within the hole or slot in the end bracket as the roller tube is rotated. In other instances, the pin may form part of or be secured to a sleeve that is rotationally secured to the idle end such that the pin remains stationary as the roller tube and the remainder of the idle end rotate.

Through the receipt of the pin within a hole or slot in the end bracket the pin holds the idle end, and hence the roller tube, in position and permits the roller tube to rotate relative to the end bracket. Unfortunately, the pin also presents a mechanism by which the roller tube may undesirably become detached from the end bracket and fall from its position above a window. In particular, where there have been errors in measuring the width of a window, or where the roller tube may have been cut slightly shorter than its optimum length, the pin may become dislodged from its position in the end bracket. Further, in situations where the roller tube is of a significant length, or if a heavy blind fabric is wound upon the tube, the roller tube can in some cases sag or deflect downwardly toward its middle, causing the pin to become dislodged from the end bracket. In such cases, the blind could fall from its position, causing damage to the blind and potentially injuring individuals or objects in close proximity.

### SUMMARY

The invention provides an idle end for a roller blind, the idle end comprising a housing that includes a roller tube engagement portion for securing said housing to an end of a roller tube; and a pin member secured to said housing, said pin member extending outwardly from the end of said housing and including a flange, said pin member releaseably securable to an end bracket of the roller blind with said flange engaging the outer surface of the end bracket upon the application of a force having a component generally parallel to the longitudinal axis of the roller tube, thereby restricting the release of said pin member and said idle end from the end bracket.

In a further aspect the invention provides an idle end for a roller blind, the idle end comprising a housing, said housing including a roller tube engagement portion for securing said housing to an end of a roller tube, and a pin member secured to said housing and independently rotatable relative to the housing, said pin member receivable within an opening in an end bracket of the roller tube to assist in hanging the roller blind from the end bracket, said pin member extending outwardly from the end of said housing and including at least one flange, said at least one flange engaging the end bracket when said pin member is received in said opening in the end bracket, the engagement of said flange with said end bracket helping to prevent the release of said pin member from the opening in the end bracket upon the application of a force having a component that is generally parallel to the longitudinal axis of the roller tube.

Further aspects of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is a front elevational view of a typical roller blind employing the idle end in accordance with an embodiment of the invention.

FIG. 2 is a right side elevational view of the roller blind shown in FIG. 1.

FIG. 3 is a partially exploded view of the idle end of the roller blind shown in FIG. 1, detached from its end bracket.

FIG. 4 is an enlarged side perspective view of the end of the roller blind shown in FIG. 3.

FIG. 5 is a side elevational view of an idle end housing in accordance with the present invention, removed from the roller tube and secured to an end bracket.

FIG. 6 is an upper side perspective view of the housing and end bracket shown in FIG. 5.

### DESCRIPTION

The present invention may be embodied in a number of different forms. The specification and drawings that follow describe and disclose some of the specific forms of the invention.

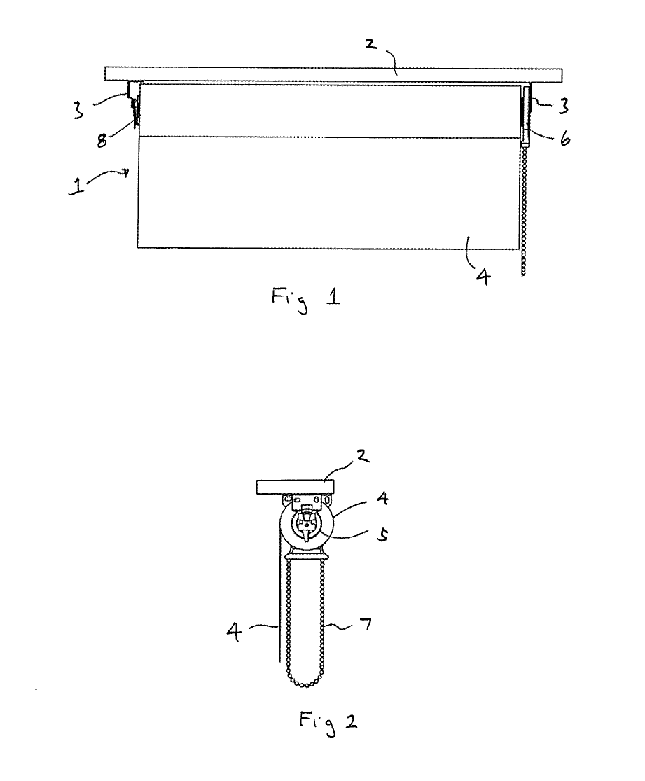

FIG. 1 shows, in front elevation, a relatively standard roller blind 1 that is mounted to a horizontal surface 2 through the use of a pair of end brackets 3. The blind fabric 4 is received about a roller tube 5 (see FIG. 2) and is wound or unwound from the roller tube through the operation of a clutch 6 which is activated by a chain or a cord 7. The opposite end of the roller tube includes an idle end 8 that is secured to the roller tube, and that generally serves to hang or secure the end of the roller tube, opposite the clutch, to its corresponding end bracket. In the embodiment shown in FIGS. 1 and 2, the end brackets are fastened (for example through the use of screws) to horizontal surface 2 in order to effectively mount the roller blind to the horizontal surface. Other manners of securing the blind in place are possible.

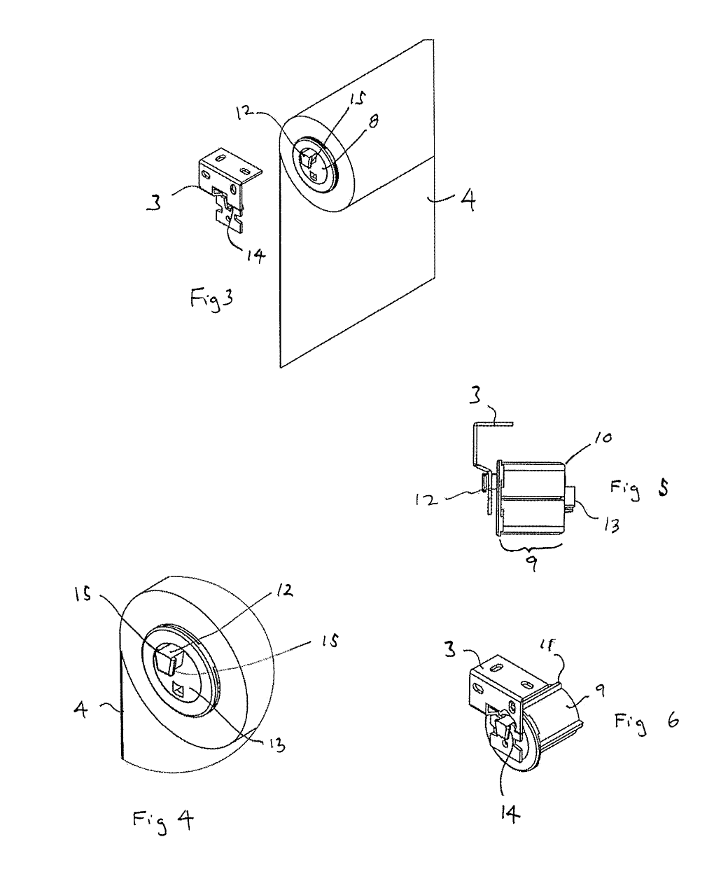

It will be appreciated by those of skill in the art that idle ends for roller blinds generally serve the purpose of “hanging” one end of a blind from an end bracket, while permitting the roller tube to rotate. With reference to FIGS. 3 through 6, idle end 8 includes a housing 9 having a roller tube engagement portion 10 that secures the housing to the end of the roller tube. In the particular embodiment depicted in the attached drawings, roller tube engagement portion 10 comprises a series of longitudinally oriented splines 11 that frictionally engage the interior surface of the roller tube when the housing is inserted therein. In so doing, splines 11, and that portion of housing 9 to which they are attached, effectively become fixed to the roller tube and rotate with it.

To permit the idle end (and hence the end of the roller tube to which the idle end is secured) to be hung from the end bracket, idle end 8 includes a pin member 12 that is secured or fastened to housing 9. In the embodiment of the invention shown, the pin member is independently rotatable relative to the roller tube, and that portion of housing 9 to which splines 11 are secured. It will be appreciated that a variety of different mechanisms could be utilized to permit housing 9 to rotate independently from the pin member. In the attached drawings pin member 12 is secured to a sleeve 13 which is received through housing 9 and which is permitted to rotate independently from the remainder of the housing. Sleeve 13 is secured to the remainder of the housing through the use of any of a wide variety of different fasteners or fastening mechanisms in order to prevent undesired longitudinal displacement of sleeve 13 and pin member 12 relative to housing 9.

In general accordance with idle ends for roller blinds, pin member 12 is releasably securable to end bracket 3. Preferably, the end bracket includes a hole, slot or opening 14 that is sized and dimensioned to receive pin member 12. Opening 14 has an open top and a closed bottom against which the pin rests when received with the opening. The cross sectional shape of the pin member could vary. In the embodiment shown in the attached drawings the pin member has a quadrilateral shape in cross section, with a top surface that is wider than its bottom surface and opposed sides that converge toward the bottom surface, presenting a wedge-like shape. Opening 14 in end bracket 3 has a corresponding or complimentary shape. Constructing the pin member with such a shape permits it to be easily “located” within correspondingly shaped opening 14 of end bracket 3, and also causes the pin member to effectively become wedged within the opening upon the application of a vertical load, thereby tending to hold the pin tightly in place within opening 14.

Pin member 12 includes at least one flange 15 that engages end bracket 3 when the pin member is received within opening 14. Flange 15 is preferably generally perpendicular to the axis of the pin member and the pin member will have a length such that its distal end extends completely through end bracket 3 with flange 15 bearing against or adjacent to the outer side surface of the end bracket. To accomplish this, the pin member will preferably be lowered downwardly through the open top of opening 14 with flange 15 received against the outer surface of the bracket. It will be understood that the dimension of flange 15 relative to opening 14 will be such that the flange will be engaged against the outer surface of the end bracket to help prevent the release of the pin member (and the idle end to which it is secured) from the end bracket upon the application of a force that has a component that is generally parallel to the longitudinal axis of the roller tube. That is, through lowering the pin member into opening 14 with flange 15 positioned against the outer side surface of the end bracket, the increased cross sectional area of the pin member at flange 15 will effectively restrict the pin from being pulled through opening 14 when a force is applied to the roller blind in a direction generally parallel to the longitudinal axis of the roller tube. For example, lengthy or blinds having heavy fabric wound thereon typically sag slightly toward their middle, resulting in the application of a force to the idle end (and hence pin member 12) that will have a component that is parallel to the longitudinal axis of the roller tube. Whereas a pin member devoid of flange 15 would exhibit a tendency to be drawn through hole 14 and to be released from contact with the end bracket, the presence of flange 15 helps to prevent that from occurring and thereby helps to prevent the unintentional falling of the roller blind.

It will also be appreciated that the number of flanges and their positions could vary while remaining within the broad scope of the invention. For example, a single flange 15 could be utilized, in which case the flange would in most cases be positioned on the bottom surface of the pin member. In some instances it could also be positioned on one of the side surfaces. Alternately, two flanges could be used, with the flanges on any combination of the two sides and the bottom surface. Further, three flanges could be utilized where each side surface and the bottom surface is fitted with a flange. In any case, the flange or flanges will restrict the unintentional withdrawal of the pin member from opening 14 while still permitting the pin to be lowered downwardly into the opening in order to releasably secure the idle end of the roller blind to the end bracket.

While a quadrilateral shaped pin has been shown and described, other shaped pins could be utilized, including a pin that is generally circular in cross-section. Where the pin is of a circular cross-section, it could also be possible for the pin to rotate with housing 9 (it may be desirable in such a case to include a bearing or bushing within the end bracket to reduce wear on the pin). In the case of a rotating pin, flange 15 would preferably extend around the circumference of the outer end of the pin to an extent that prevents the flange from being pulled through opening 14 while the pin rotates. With such a flange the pin member can be lowered into opening 14 with flange 15 adjacent to the outer surface of the end bracket and with the dimensions of the flange preventing it from being pulled through the opening should a longitudinal force be applied to the pin/roller tube as they rotate.

The scope of the claims should not be limited by the preferred embodiments set forth in the examples, but should be given the broadest interpretation consistent with the description as a whole.

I claim:

1. An idle end for a roller blind, the idle end comprising:
i) a housing that includes a roller tube engagement portion for securing said housing to an end of a roller tube; and
ii) a pin member secured to said housing, said pin member extending outwardly from the end of said housing and including a flange, said pin member releaseably securable to an end bracket of the roller blind with said flange engaging the outer surface of the end bracket upon the application of a force having a component generally parallel to the longitudinal axis of the roller tube thereby restricting the release of said pin member and said idle end from the end bracket.

2. The idle end as claimed in claim 1 wherein the end bracket includes a slot or opening, said pin member releasably receivable within the slot or opening with said flange received adjacent to the outer surface of the end bracket.

3. The idle end as claimed in claim 2 wherein said pin member is independently rotatable relative to said housing.

4. The idle end as claimed in claim 3 wherein said flange is generally perpendicular to the longitudinal axis of said pin member.

5. The idle end as claimed in claim 4 wherein said pin member is quadrilateral in cross section, having a top, a bottom and two side surfaces.

6. The idle end as claimed in claim 5 wherein said flange is on said bottom surface.

7. The idle end as claimed in claim 5 wherein said flange is on one of said side surfaces.

8. The idle end as claimed in claim 5 having two flanges, one on each of said side surface.

9. The idle end as claimed in claim 4 having three flanges, one on each of said side surfaces and one on said bottom surface.

10. An idle end for a roller blind, the idle end comprising:
i) a housing, said housing including a roller tube engagement portion for securing said housing to an end of a roller tube, and
ii) a pin member secured to said housing and independently rotatable relative to the housing, said pin member receivable within an opening in an end bracket of the roller tube to assist in hanging the roller blind from the end bracket, said pin member extending outwardly from the end of said housing and including at least one flange, said at least one flange engaging the end bracket when said pin member is received in said opening in the end bracket, the engagement of said flange with said end bracket helping to prevent the release of said pin member from the opening in the end bracket upon the application of a force having a component that is generally parallel to the longitudinal axis of the roller tube.

11. The idle end as claimed in claim 10 wherein said flange is generally perpendicular to the longitudinal axis of said pin member and the longitudinal axis of the roller tube.

12. The idle end as claimed in claim 11 wherein said pin member is quadrilateral in cross-section having a bottom surface, a top surface and two side surfaces.

13. The idle end as claimed in claim 12 wherein said flange is on said bottom surface.

14. The idle end as claimed in claim 12 wherein said flange is on one of said side surfaces.

15. The idle end as claimed in claim 12 including two flanges, one on each of said side surfaces.

16. The idle end as claimed in claim 12 including three flanges, one on said bottom and each of said side surfaces.
